(19) United States
(12) Patent Application Publication
(10) Pub. No.: US 2005/0033713 A1
(43) Pub. Date: Feb. 10, 2005

(54) Automatic text generation

(75) Inventors: Aravind Bala, Bellevue, WA (US); Andrew McGlinchey, Seattle, WA (US); Saikat Sen, Redmond, WA (US); James D. Jacoby, Snohomish, WA (US); Hsiao-Wuen Hon, Bellevue, WA (US)

Correspondence Address: Nathan M. Rau;Westman, Champlin & Kelly, Suite 1600, 900 Second Avenue, Minneapolis, MN, 55402-3319, US

(73) Assignee: Microsoft Corporation, Redmond, WA (US)

(21) Appl. No.: 10/887,058

(22) Filed: Jul. 8, 2004

Related U.S. Application Data
(63) Continuation-in-part of application No. 10/337,745, filed on Jan. 7, 2003.

(51) Int. Cl. G06N 5/04; G06N 5/02; G06F 9/44

(52) U.S. Cl. 706/59; 706/45; 706/48; 706/50; 706/61; 706/60; 706/51; 717/106; 717/109

(57) ABSTRACT

A text generator automatically generating a text document based on the actions of an author on a user interface. To generate the text document the author activates a recording component. The recording component records the author's actions on the user interface. Based on the recorded actions, a text generation component searches a text database and identifies an entry that matches the author's recorded actions. This text is then combined to form a text document, which provides instruction or other information to a user. During the process of generating the text document, the text can be edited using an editor as desired, such as to enhance the comprehensibility of the document.

### RELATED APPLCIATIONS

The present invention is a continuation in part of co-pending U.S. patent application Ser. No. 10/337,745, filed Jan. 7, 2003, entitled Active Content Wizard: Execution of Tasks and Structured Content, and assigned to the same assignee as the present invention. Further, reference is made to U.S. patent applications; Ser. No. 10/______, filed Jul. 8, 2004, entitled Importation of Automatically Generated Content; U.S. patent applications; Ser. No. 10/______, filed Jul. 8, 2004, entitled Automatic Image Capture for Generating Content, and assigned to the same assignee as the present invention.

### BACKGROUND OF THE INVENTION

The present invention deals with generating text. More specifically, the present invention deals with automatic generation of text indicative of actions of a user on a user interface.

There have been several attempts to enable natural language/speech based interaction with computers. The results of these attempts have so far been limited. This is due to a combination of technology imperfections, lack of non-intrusive microphone infrastructure, high authoring costs, entrenched customer behaviors and a competitor in the form of the GUI (Graphical user interface), which offers high value for many tasks. The present invention focuses on two of these limitations, closer integration with the GUI and reduced authoring costs.

The Graphical User Interface (GUI) is a widely used interface mechanism. GUI's are very good for positioning tasks (e.g. resizing a rectangle), visual modifier tasks (e.g. making something an indescribable shade of blue) or selection tasks (e.g. this is the one of a hundred pictures I want rotated). The GUI is also good for speedy access to quick single step features. An applications GUI is a useful toolbox that is organized from a functional perspective (e.g. organized into menus, toolbars, etc) rather than a task oriented perspective (e.g. organized by higher level tasks that users want to do, such as “make my computer secure against hackers”).

However, GUIs present many problems to the user as well. Using the toolbox analogy, a user has difficulty finding the tools in the box or figuring out how to use the tools to complete a task. An interface described by single words, tiny buttons and tabs forced into an opaque hierarchy doesn't lend itself to the way people think about their tasks. The GUI requires the user to decompose the tasks in order to determine what elements are necessary to accomplish the task. This requirement leads to complexity. Aside from complexity, it takes time to assemble GUI elements (i.e. menu clicks, dialog clicks, etc). This can be inefficient and time consuming even for expert users.

One existing mechanism for addressing GUI problems is a written help procedure. Help procedures often take the form of Help documents, PSS (Product support services) KB (Knowledge base) articles, and newsgroup posts, which fill the gap between customer needs and GUI problems. They are analogous to the manual that comes with the toolbox, and have many benefits. These benefits include, by way of example:
1) They are relatively easy to author even for non-technical authors;
2) They are easy to update on a server so connected users have easy access to new content; and
3) They teach the GUI thereby putting users in control of solving problems.

However, Help documents, PSS KB articles and newsgroups have their own set of problems. These problems include, by way of example:
1) Complex tasks require a great deal of processing on the user's part. The user needs to do the mapping from what is said in each step to the GUI.
2) Troubleshooters, and even procedural help documents, often include state information that creates complex branches within the help topic, making topics long and hard to read and process for the user. Toolbars may be missing, and may need to be turned on before the next step can be taken. Troubleshooters often ask questions about a state that is at best frustrating (because the troubleshooter should be able to find the answer itself) and at worst unanswerable by non-experts.
3) There are millions of documents, and searching for answers involves both a problem of where to start the search, and then how to pick the best search result from the thousands returned.
4) There is no shared authoring structure. Newsgroup posts, KB articles, troubleshooters and procedural Help documents all have different structures and authoring strategies, yet they are all solving similar problems.

Another existing mechanism for addressing GUI problems is a Wizard. Wizards were created to address the weaknesses of GUI and written help procedures. There are now thousands of wizards, and these wizards can be found in almost every software product that is manufactured. This is because wizards solve a real need currently not addressed by existing text based help and assistance. They allow users to access functionality in a task-oriented way and can assemble the GUI or tools automatically. Wizards allow a program manager and developer a means for addressing customer tasks. They are like the expert in the box stepping the user through the necessary steps for task success. Some wizards help customers setup a system (e.g. Setup Wizards), some wizards include content with features and help customers create content (e.g. Newsletter Wizards or PowerPoint's AutoContent Wizard), and some wizards help customers diagnose and solve problems (e.g. Troubleshooters).

Wizards provide many benefits to the user. Some of the benefits of wizards are that:
1) Wizards can embody the notion of a “task.” It is usually clear to the user what the wizard is helping them accomplish. With step-by-step pages, it is easy for a user to make choices, and in the case of well designed wizards the incidence of the user becoming visually overwhelmed is often reduced.
2) Wizards can automatically assemble and interact with the underlying features of the software and include the information or expertise needed for customers to make choices. This saves the user time in executing the task.
3) Wizards can automatically generate content and can save users time by creating text and planning layout.
4) Wizards are also a good means for asking questions, getting responses and branching to the most relevant next question or feature.

However, wizards too, have their own set problems. Some of these problems include, there are many more tasks that people try to accomplish than there are wizards for accomplishing them. Wizards and IUI (Inductive User Interfaces) do not teach customers how to use underlying GUI and often when the Wizard is completed, users are unsure of where to go next. The cost of authoring of wizards is still high and requires personnel with technical expertise (e.g. software developers) to author the Wizard.

### SUMMARY OF THE INVENTION

The present invention addresses some of the problems of Wizards, Help, Knowledge base articles and troubleshooters by providing a content wizard that allows for an easy way to author thousands of tasks (or wizards), and either integrate with the GUI and teach the user how to use the GUI to execute the task or to execute the task on behalf of the user. Specifically, the present invention deals with authoring of active content wizard (ACW) scripts, and specifically with authoring the text that is part of an ACW script.

The present invention is directed to a system for automatically generating a text document based on the actions of an author on a user interface. To generate the text document the author activates a recording component. The recording component records the author's actions on the user interface. The recording component passes the recorded actions to a text generation component. Based on the properties of the recorded actions (including user interface controls and author actions) the text generation component searches a text database and identifies an entry that matches the author's recorded actions. This text generator can generate this text based on a system of rules. This text is then combined to form a text document, which provides instruction or other information to a user. During or after the process of generating the text document, the text can be edited using an editor to enhance the comprehensibility of the document.

### BRIEF DESCRIPTION OF THE DRAWINGS

FIG. 1 is a block diagram of one exemplary environment in which the present invention can be used.

FIG. 2 is a block diagram illustrating the components of an automatic text generating system of the present invention.

FIG. 3 is a screen shot illustrating an example of a graphical user interface upon which the present invention can be used.

FIG. 4 is a flow diagram illustrating steps executed during the generation and editing of a text document according to one embodiment of the present invention.

FIG. 5 is a screen shot illustrating and exemplary display that can be used for recording.

FIG. 6. is a screen shot illustrating one embodiment of user interface control elements for controlling the recording tool of the present invention.

FIG. 7 is a screen shot illustrating a highlighting feature of the present invention.

FIG. 8 is a screen shot illustrating one way of presenting the generated text to an author for editing.

FIG. 9 is a flow diagram illustrating in more detail the steps that are executed during automatic text generation for a received command.

### DETAILED DESCRIPTION OF ILLUSTRATIVE EMBODIMENTS

The present invention deals with automatically generating text based on a user action on a user interface. Prior to describing the present invention in greater detail, one exemplary environment in which the invention can be used will be discussed.

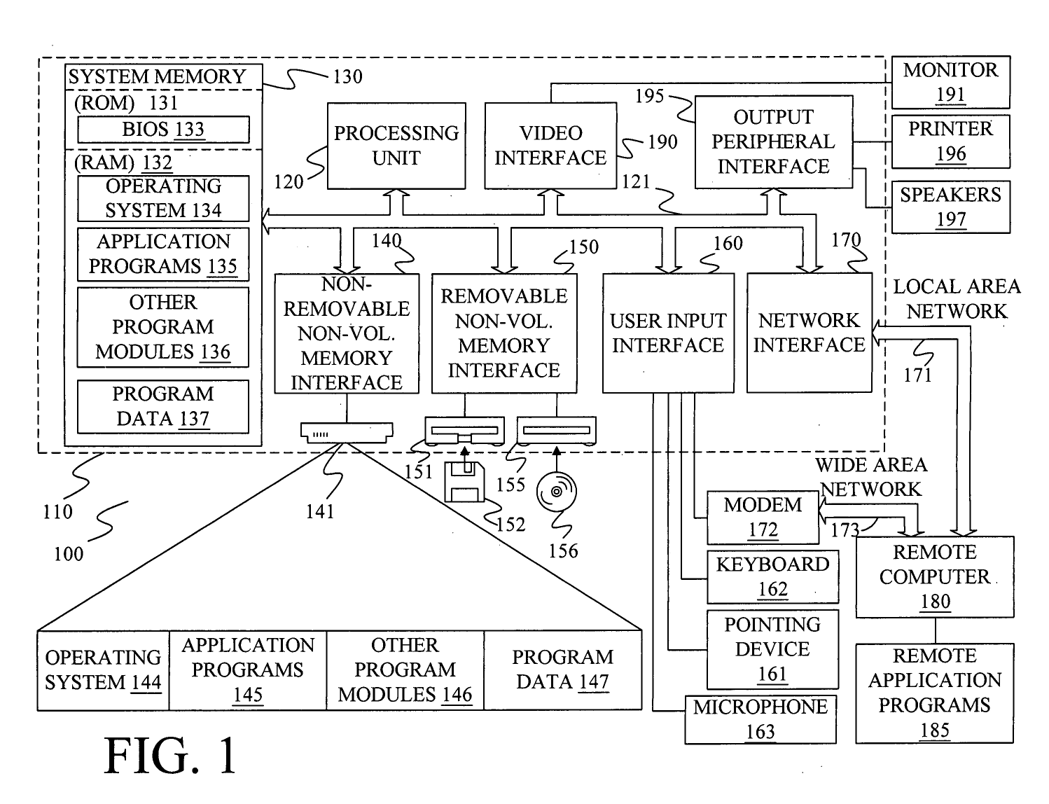

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage. media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

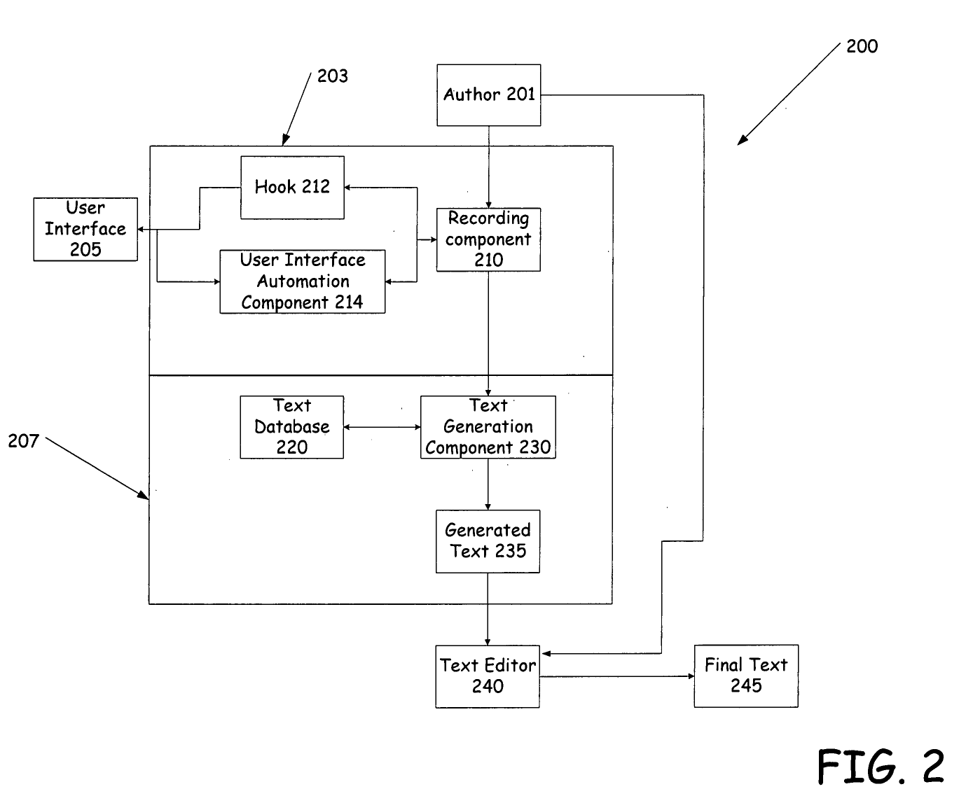

FIG. 2 is a block diagram illustrating the components of an automatic text generating system 200 according to one embodiment of the present invention. The text generating system 200 has a recorder 207 and a text generator 203. The recorder 207 includes a recording component 210, a hook component 212, and a user interface (UI) automation component 214. Optionally, an image-capturing component can also be provided. The text generator 203 includes a text database 220, and text generation component 230. The text generation system 200 interacts with a user interface 205. An author can configure the components of system 200 to automatically record actions performed on the controls of user interface 205, and automatically generate texts 235 that describes those actions. Author 201 can also edit the automatically generated text 235 to obtain final text 245 describing the task (or UI control actions). A number of the components in FIG. 2 will now be described in greater detail.

User Interface 205 is in one embodiment a graphical user interface with controls that allow a user to take actions to perform a task. The user interface 205 is displayed on display device 191 shown in FIG. 1. The Graphical User Interface (GUI) is a widely used interface mechanism.

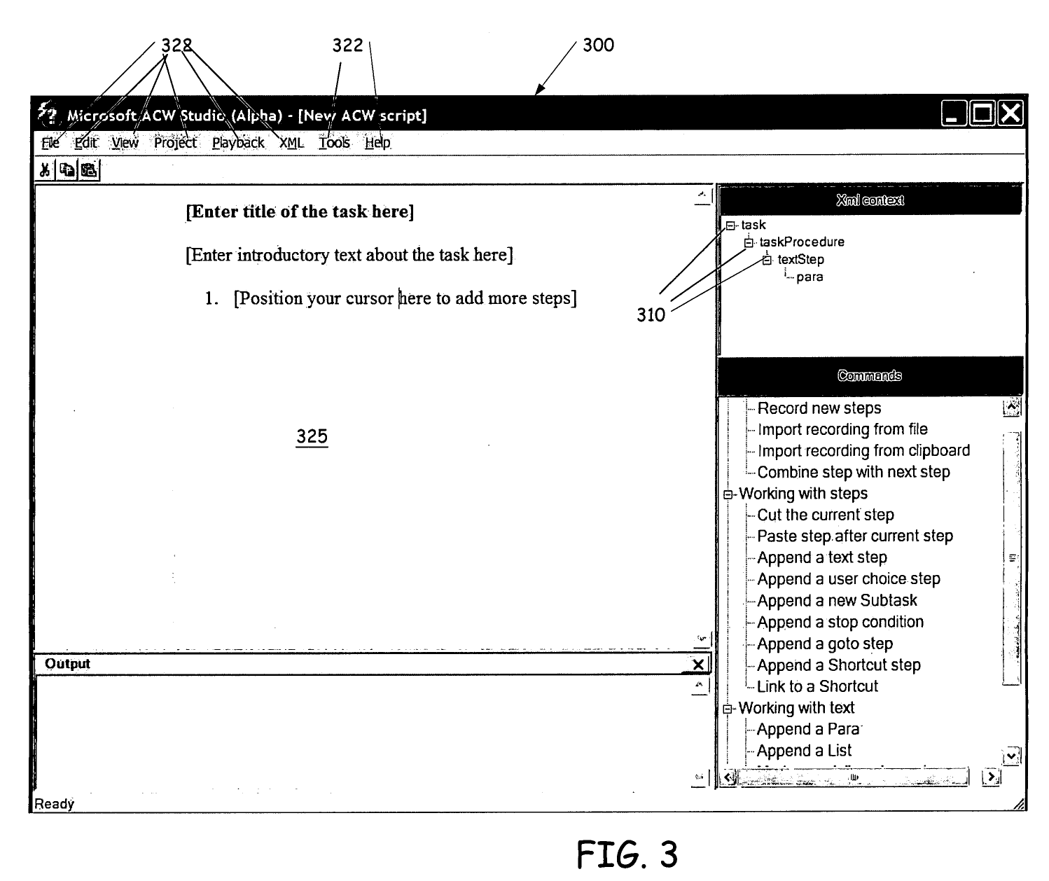

FIG. 3 is a screen shot illustrating one example of a GUI that can be used with the present invention. In this example, the GUI is divided into a background portion (not illustrated) and a window portion 300, and includes a series of controls 310. Controls 310 can illustratively include list boxes, buttons, tabs, tree controls, and list view items. However, other types of controls can be present within the GUI, and those shown and listed are exemplary only. The window portion 300 is further divided into a tool bar portion 320 and an application portion 325. The tool bar portion 320 has a series of tasks arranged into menus 322 that may be selected by the user during a normal operation of the associated application. These menu items may include further pull down menus or options, and may also cause another window/GUI to pop-up on the screen.

Recording component 210 is in one embodiment an application program that allows the author 201 or another user to perform a task on the user interface 205, and records the tasks. While the author 201 is performing the steps associated with the task on the user interface 205, the recording component 210 records information about what controls and windows the author interacts with on the user interface 205. This information is provided to the text generator 230 to generate the text in a document, such as a help document.

The recording component 210 interacts with the user interface 205 through the hook 212 and the user interface (UI) automation component 214. These components can be separate from the recording component 210, or in some embodiments these components can be integral with the recording component 210.

The hook component 212 is in one embodiment a module or component within an operating system that is used by the computer. When a hook is set for mouse clicks, for example, the mouse click is forwarded to the hook component 212 where it is consumed, and after it has been recorded by the recording component 210, it is played back for other components in the computer that have registered to receive mouse clicks. Therefore, generally, the hook component 212 acts as a buffer between the operating system and the target application. The hook component 212 can be configured to look for substantially any input action, such as the type of signal received, e.g. single click, double click, right or left click, keyboard actions, etc. Once the information representing the action is recorded by the recording component 210, the information representing the mouse click (or whatever action recorded) is then played back by the hook component 212 to the application. One reason for this is that the user may take a second action before the first action is recorded. The second action may well cause the state of the user interface to change, and thus result in improper recording of the first action. By consuming the first action and playing it back once recording is complete, this ensures that the first action will be recorded properly.

It should also be noted that the functions performed by the hook component 212 (i.e., listening for mouse clicks and playing them back) are illustratively performed on separate threads. This ensures that all user interface actions (e.g., mouse clicks, keyboard actions, etc.) will be properly recorded and played back without missing any. Further, the record and playback mechanism of the hook component 212 can override any timeout features that are implicit within the operation system. This can be necessary if the timeout period of the operating system is too short to allow for proper recording of the action.

User interface automation component 214 is illustratively a computer program configured to interpret the atomic steps for the task performed by the author or user through the user interface 205. In one embodiment, user interface automation component 214 is a GUI automation module implemented using Microsoft User Interface Automation by Microsoft Corporation. This module provides a programmatic way to access information about the visible user interface, and to programmatically interact with the visible user interface. However, depending on the system setup, the user interface automation component 214 can be implemented using any application that is able to programmatically navigate a graphical user interface and to perform, execute, and detect commands on the user interface.

User interface automation component 214 thus detects each of the steps associated with the desired task performed on the user interface 205 by author 201 (or another user) in task order. For instance, when the task requires the user to click a button on the GUI to display a new menu or window, UI automation component 214 determines which control is located at the position of the mouse on the user interface 205. The recording component 210 uses information from the hook component 212 (e.g. which mouse button was clicked and where the mouse cursor is on the user interface), with information from the UI automation component 214 (e.g. the type, name and state of the control) to record the name and properties of the control that was used by the author to perform the step. This information determined by the user interface automation component 214 is provided to the recording component 210 such that the recording component 210 can record the name, state, and type of the control that was used by the author to perform the step.

Text generation component 230 is a program or module configured to generate natural language text that describes the actions executed or performed during the recording process. The text generation component 230 uses the recorded information recorded by the recording component 210 to choose a correct template or entry from the text database 220.

Text database 220 is illustratively a database or other information storage system that is searchable by the text generator 230. Text database 220 contains information related to the controls that are available on the user interface 205. This information can include, for example, the name of the control, the type of control, the action performed on the control, and a textual description of the action as a natural language sentence.

In some embodiments the textual description for the entry is provided in multiple languages. When the textual description is provided in multiple languages, a language identifier is provided with each entry that allows the correct language to be selected.

However, depending on the needs of the system, other information can be provided in the text database 220. In one embodiment, some entries in the text database 220 have information related to two or more actions exemplified by multiple controls that are performed in sequence. Where multiple actions on multiple controls are represented by a single entry in the text database 220 the text for the entry contains natural language descriptions of the action performed on both controls as a single sentence. By combining the description of the two commands as a single sentence, the readability of the final text document is improved.

In one embodiment, the text database 220 is written in Extensible Markup Language (XML). The data for each entry can be stored as a series of subentries, where each subentry of the entry refers to an individual piece of information that is needed to identify the task. However, other formats can be used for storing the data.

In one embodiment, the text generation component 230 looks at two or more of the recorded actions when searching for entries in the text database 220. This can be done in order to provide a more fluid text document. For instance, good procedural documentation often combines more than one step into a single sentence as an enhancement to readability. If the text generation component 230 identifies two or more that match the recorded information in the text database 220, the text generation component 230 can use any known method to determine which entry in the database to choose, such as by disambiguating the entries based on scoring each entry, and selecting the entry that has the highest score.

According to one embodiment, based on the type of the control actuated on the user interface, and the performed action, the text generation component 230 searches the text database 220 for an entry that matches the executed control type and action. Once a match is identified in the text database 220, the text generation component 230 obtains the associated natural language description of the action from the text database 220, and places it as a sentence instruction in the generated text document 235. In an alternative embodiment, the text generation component 220 can also generate an executable version of the text document based on the information provided by the UI automation module 214.

When choosing a textual description from the text database 235, the text generation component can also look to the state of the control. This is important when the control is a checkbox or an expandable or collapsible tree. In this case merely clicking on the box may not be the appropriate action to describe the action, as the action on the control is the same regardless of the desired result. Therefore, in these case the new state of the control will influence the selected text. For example, if the control is a check box and it is to be deselected, the text matched would be based on the new state of the control plus the controls name.

Text editor 240 is an editor configured to correct, change, or add information or text to the automatically generated text 235. Depending on the resultant text generated by text generator 230, and the actions performed by the author, it may be necessary to edit the text to further enhance its understandability. Therefore, text editor 240 receives the generated text 235, and allows the author 201 to edit the generated text.

Text editing may be required, for example, because of a grammatical necessity or because one of the recorded steps required a user action, and the system did not request the description of the user action at the time it was recorded. In such a case (when a user input is required), while performing the task to be recorded according to one embodiment, the text generator 235 only provides a space in the text for the author to provide an instruction/description of what the user should do at this step.

For example, assume that the task being performed by the user and recording component is to change the background paneling on the computers screen. This requires the user to choose a pattern for the background. Therefore, the text that is returned by the text database for a recorded user action to change the background can be “Please select [insert description of action]”, where the author will have to edit the text to read “Please select the desired background from the list.” Also during the editing stage the author 201 can provide a description of the overall task if this was not provide prior to recording the task. Once the text has been edited the final text 245 is-output from the authoring tool 200 and is stored in an appropriate storage mode that allows for the final text to be retrieved by a user when desired.

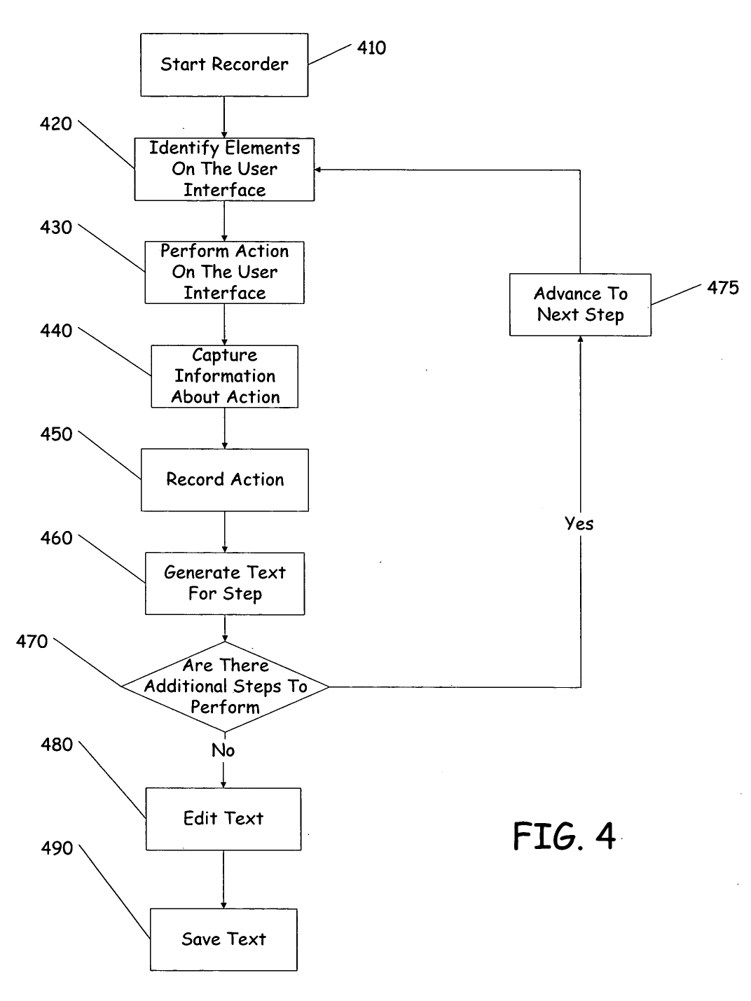

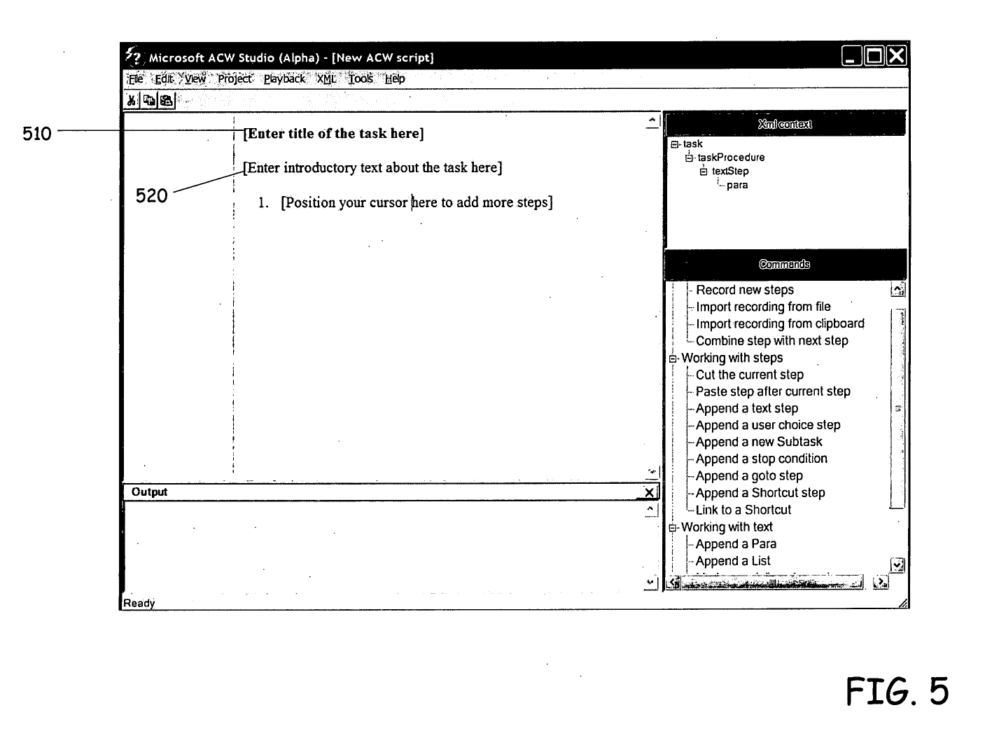

FIG. 4 is a flow diagram illustrating the steps executed during the authoring of a text document according to one embodiment of the present invention. For purposes of this discussion it will be assumed that the document being written is a help document. Help documents are useful to the users of applications in that they provide assistance in a written format that explains to the user how to perform a desired task. Also during the discussion of the flow diagram of FIG. 4, reference will be made to various exemplary screen shots. These screen shots are illustrated in FIGS. 5 to 8.

First the author of the help document activates the recording component. The recording component is similar to recording component 210 illustrated in FIG. 2. The author activates the recording component by first opening a window similar to the one illustrated in FIG. 5. At this point the author can edit the portion of the screen indicated by lines 510 and 520, to include information such as a title of the document being created and any introductory information regarding the task. However, as discussed above this information can be added to the text document during later editing. The activation of the recording component is illustrated by step 410. Also during this step the recording tool is displayed to the author.

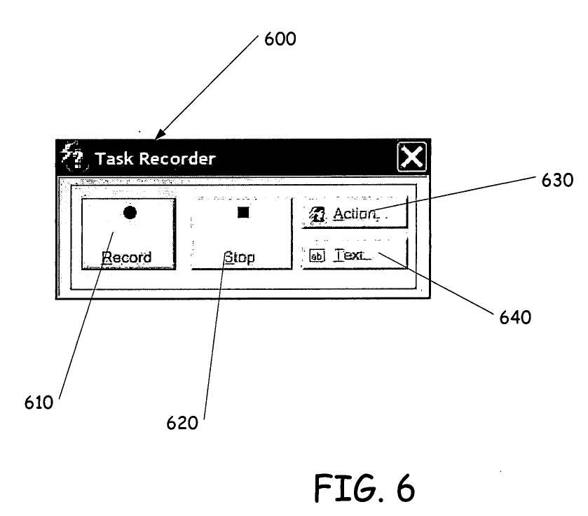

One embodiment of a user interface representing the recording tool by display element 600 is illustrated in FIG. 6. This represents that the recording tool has a record button 610, a stop button 620, a user action button 630, and a text button 640. By activating the recording button 610, the recording component 210 records the actions of the author (or other user) on the user interface 205. Recording is stopped when the author selects the stop button 620. If the action requires a user action, the author selects the action button 630. If the author desires to edit the text of the document during the recording process, the author can select the text button 640. Additionally, in some embodiments, an additional button may be present. This additional button allows the user to set a value. This is to allow correct text to be generated when at runtime the user may have to type a text into an edit box.

Prior to beginning to record the action, the author, if needed, opens up the application that the text document is to be written for. However, if the text document is designed to be run outside of the framework of an application program, then no window is opened prior to recording the actions on the user interface.

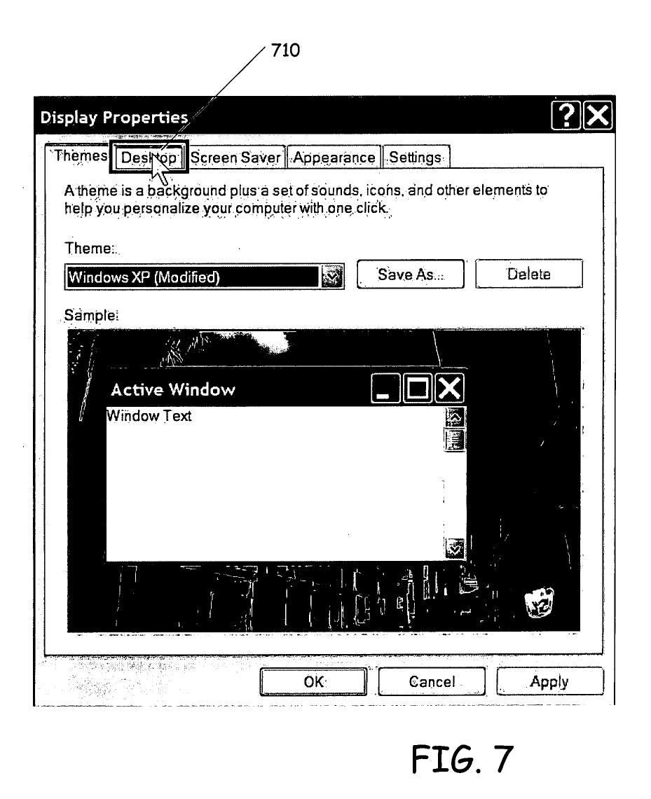

The recording process is started when the author selects the record button 610 on the recording tool 600. At this point the UI automation component 214 determines the available functions and components that are on the user interface 205. This is illustrated at step 420 of FIG. 5. Also the recording component 210 provides an indication on the user interface of what command or function is currently identified as the command being accessed using information provided from the UI automation component 214. This highlighting of the command is illustrated by reference number 710 in FIG. 7.

Next the author executes the desired command on the screen. This is illustrated at step 430 of FIG. 4. Then the recording component 210 captures the information related to the command using the hook component 212. This is illustrated at step 440. The command is recorded by the recording component at step 450 of FIG. 4. In one embodiment of the present invention the information that is recorded at step 450 includes the type of the command, plus the state of the control, as well as the type of input provided by the author. As discussed above, this information is received from the UI automation component 214. However, other information can be provided by the UI automation component 214 during the recording process. Once the command has been recorded by the recording component the hook component 212 passes, retransmits or replays the command to the operating system, which sends the command to the application program to programmatically execute the command on the application. The hook component 212 holds the command from being passed to the application to ensure that the UI automation component 214 has time to pass the required information to the recording component.

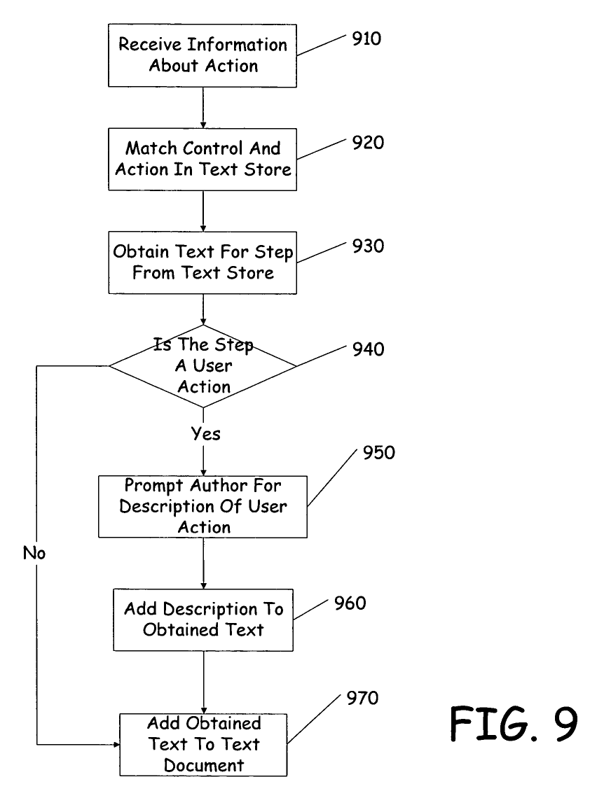

Then the recording component 210 passes the information recorded to the text generation component 230 to generate a text that is a suitable description of the received command. This is illustrated at step 460 of FIG. 4. One example of a process for obtaining this text is illustrated with respect to FIG. 9, which is described in greater detail below.

Following the generation of text for the specific step of the task just performed at step 460, the recording component determines whether there are additional steps to be performed. This is illustrated at step 470. In one embodiment of the present invention this check is performed automatically by the recording component 210. For example, if the result of the recorded command caused another window to open or pop-up, the system will assume there is another step to be recorded. In another embodiment, the system assumes there is another step to be recorded, unless the author selects the stop button 620 from the recording tool shown in FIG. 6. If there is another step to be performed, the system advances to the next step in the task at step 475, and repeats steps 420 through 470.

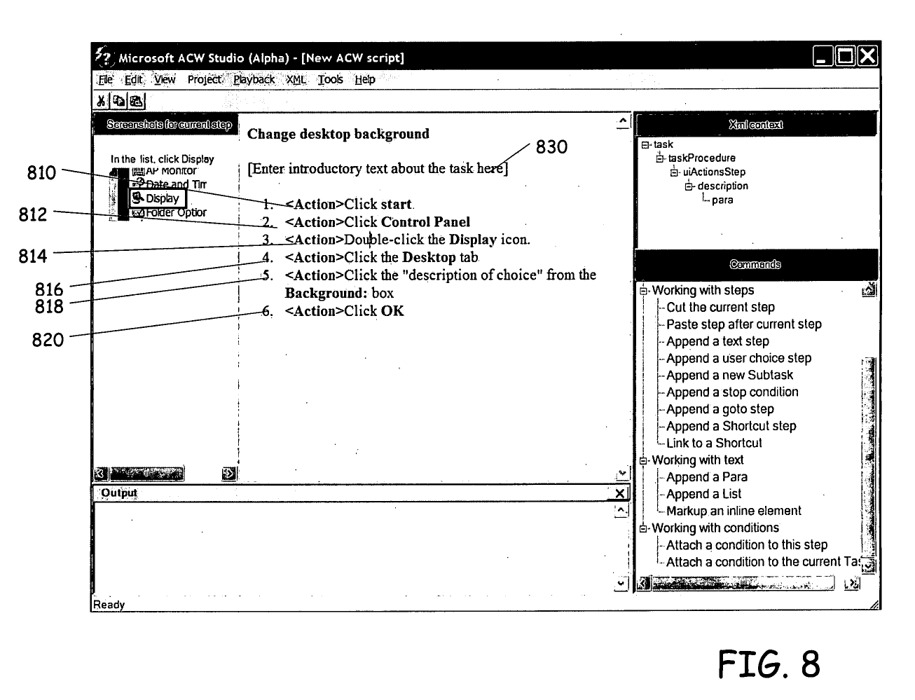

An example of the generated text is illustrated in FIG. 8 by reference number 810-820. This text provides the user with the step by step instructions for the desired task. The text can be generated as described to text database 220 and text generation component 230, or according to any method that allows for the automatic generation of text from received input commands.

Once all of the steps have been completed the system enters the editing text mode. At this time the author201 is presented with all of the steps that were recorded and the associated text generated by the text generator component 230. The author then reviews the text and makes any necessary corrections to the text at step 480. These corrections can include changing the grammatical structure of the generated text, adding information to the generated text to increase the comprehensibility of the text, deleting an unwanted step, or any other editing. An example of the text that is displayed prior to editing is illustrated in FIG. 8. In one embodiment, the text can be edited in the authoring tool. However, in other embodiments the text of the document can be edited in a word processor such as Microsoft Word or Notepad or any other program with an editor. In FIG. 8, the author may desire to add additional information describing the action at line 830, or provide the requested information at the phrase “description of choice” at line 818.

Once the text document has been edited, a final version of the text document is saved at step 490. The document is saved in any manner that permits the document to be easily retrieved when requested. In one embodiment the text documents are saved as a portion of an on-line help program. Also, during the authoring of the text document, an executable file can be generated that corresponds to the recorded steps.

The executable version of the document is created in one embodiment, according to the method described in U.S. Ser. No. 10/337,745.

FIG. 9 is a flow diagram illustrating in more detail the steps that are executed to generate text for a received command according to one embodiment of the present invention. At step 910 the information related to the recorded command is received from the recording component 210 at the text generation module 230. As discussed above, this information is provided by the UI automation component 210. However, other devices or techniques can be used to obtain the information related to the selected item on the user interface.

Once the information related to the command has been received by the text generator component, the text generator component 230 proceeds to search the text database for entries that match the received command. In one embodiment, text database 220 is an XML database containing a plurality of entries that includes the type of control or other item interacted with, the type of action, a new state of the control (e.g. checked, unchecked, expanded, collapsed, etc.) and a text for the action. However, other data storage methods can be used to hold the text. Further, other information can be held in text database 220. An example of a portion of the text database according to one embodiment is provided below in Table 1.

TABLE 1

```
<EnglishTemplate actionTypeID=“value”
controlTypeID=“check box” ActionText=“Select”
specialValueID=“checked”>
  <Sentence>Select the <tag id=“1”></tag>
checkbox</Sentence></EnglishTemplate>
  <EnglishTemplate actionTypeID=“invoke”
controlTypeID=“button” ActionText=“Click”>
  <Sentence>Click <tag
id=“1”></tag></Sentence></EnglishTemplate>
  <EnglishTemplate actionTypeID=“invoke”
controlTypeID=“list item” ActionText=“Double-click”>
  <Sentence>In the <tag id=“2”></tag> list, double-
click <tag id=“1”></tag></Sentence></EnglishTemplate>
  <EnglishTemplate actionTypeID=“expand_collapse”
controlTypeID=“tree item” ActionText=“Expand”
specialValueID=“expanded”>
  <Sentence>Click the minus sign next to <tag
id=“1”></tag> to collapse
it</Sentence></EnglishTemplate>
```

For example, assuming that the information received from the recording component for the command was action type=“invoke” control type=“button” control name=“OK” “click”, then the text generation component 230 searches the text database 220 and finds an entry that matches this information. Then it retrieves the text from the entry of “click OK”. This obtaining of the text is illustrated at step 930.

During the recording of the step in question if the author designated the step a user action step by selecting the user action button 630 on the user interface 600 shown in FIG. 6, or if the entry in the text database 220 indicates that the action is a user action, the text generating component 230 can, in one embodiment, prompt the author to add a description of the desired action to the obtained text. This is illustrated at step 940. The author can then provide the text at step 950. However, the author can ignore this step and add the information later during the editing stage. Any added text is added to text 235 at step 960.

If there is no user action required, or the necessary user action information has been provided by the author, the text generator 230 provides the obtained text to the text document. This is illustrated at step 970. It should be noted that steps 910-970 in FIG. 9 corresponds to step 460 in FIG. 4.

Although the present invention has been described with reference to particular embodiments, workers skilled in the art will recognize that changes may be made in form and detail without departing from the spirit and scope of the invention.

1. A text generation system configured to generate text in response to at least one action performed on a user interface, comprising:
a recording component configured to record features corresponding to the at least one action on the user interface; and
a text generation component configured to receive the features from the recording component and to output generated text based on the features.

2. The text generation system of claim 1 wherein the recording component is configured to receive features from a user interface automation component that is configured to identify a plurality of features associated with each action on the user interface.

3. The text generation system of claim 2 wherein the action is performed by actuating a control on the user interface and wherein the plurality of features further comprises:
a control name;
a control type; and
an identification of the action performed on the control.

4. The text generation system of claim 3 further comprising:
a text database, searchable by the text generation component, having a plurality of entries each entry including text associated with at least one.

5. The text generation system of claim 4 wherein each entry in the text database includes a plurality of subentries, the subentries comprising:
text associated with the plurality of features; and
a textual description of the action performed.

6. The text generation system of claim 5 wherein the textual description of the action includes textual descriptions in multiple languages.

7. The text generation system of claim 5 wherein the textual description of the action is a natural language textual description of the action.

8. The text generation system of claim 5 wherein the text generation component is configured to identify an entry in the text database by matching recorded features received from the recording component against entries or subentries in the text database.

9. The text generation system of claim 5 wherein the text generation component outputs the textual description for the entry in response to the match.

10. The text generation system of claim 8 wherein the text generation component is configured to search the text database to identify a matching entry by matching features recorded for a combination of actions against an entry in the text database.

11. The text generation system of claim 10 wherein the text generation component is configured to output a textual description of the combination of actions from the matching entry.

12. The text generation system of claim 2 wherein the user interface automation component is further configured to provide a plurality of executable commands to the recording component associated with an action on the user interface, and wherein the text generation component is further configured to generate an executable version of the generated text based on the executable commands.

13. The text generation system of claim 1 further comprising:
a text editing component configured to allow editing of the generated text.

14. A method of generating a text describing a task performed on a user interface, comprising:
performing a series of steps associated with the task;
recording each of the series of steps with a recorder component;
obtaining, from a text store, text associated with each of the series of steps; and
generating the text from the obtained text.

15. The method of claim 14 wherein recording each of the series of steps further comprises:
receiving an indication of elements available on a user interface;
receiving an indication of a control on the user interface being manipulated; and
recording features associated with the control being manipulated on the user interface.

16. The method of claim 15 wherein recording features further comprises:
holding the user interface in a given state until the features are recorded; and
then executing the command on the user interface.

17. The method of claim 15 wherein the indication of elements available on the user interface and the indication of a control being manipulated are. received form a user interface automation component.

18. The method of claim 17 further comprising:
generating an executable version of the generated text.

19. The method of claim 16 wherein the user interface automation component further provides executable information to the text generation component.

20. The method of claim 14 further comprising:
editing the generated text.

21. The method of claim 14 wherein obtaining text from the text store comprises:
receiving an indication of recorded features associated with one of the series of steps from the recording component;
searching the text store for entries matching the received features; and
retrieving a textual description from the matching entry.

22. The method of claim 21 wherein obtaining text from the text store further comprises:
receiving an identification of recorded features associated with at least two steps from the recording component;
searching the text store for entries matching the at least two steps; and
providing a textual output for the matching entry.

23. The method of claim 21 wherein generating text further comprises:
determining whether one of the steps requires a user input; and
if so, providing a description of the user input along with the obtained text from the text store.
